(19) United States
(12) Patent Application Publication
(10) Pub. No.: US 2010/0177063 A1
(43) Pub. Date: Jul. 15, 2010

(54) PAGE CHANGE INDICATION DEVICES AND METHODS FOR DIGITAL PENS

(75) Inventors: Nathan ALTMAN, RaAnana (IL); Noam Kedem, Moshav Lahish (IL); Meir Agassy, Ramat-Gan (IL); Michael Kokarev, Haifa (IL)

Correspondence Address: MARTIN D. MOYNIHAN d/b/a PRTSI, INC., P.O. BOX 16446, ARLINGTON, VA, 22215, US

(73) Assignee: EPOS Development Ltd., Hod-HaSharon (IL)

(21) Appl. No.: 12/683,532

(22) Filed: Jan. 7, 2010

Related U.S. Application Data
(60) Provisional application No. 61/142,921, filed on Jan. 7, 2009.

(51) Int. Cl. G06F 3/033; G06K 7/10; G06F 17/00

(52) U.S. Cl. 345/179; 235/462.01; 235/375

(57) ABSTRACT

A digital pen input system for allowing a user to write or draw by interacting with sheets of paper and allowing electronic tracing of pen movements for digital storage or display, the input device comprising a holder for sheets of paper, and a unit for detecting exchange of a current sheet, the system comprising: an autonomous page changing detector for autonomously detecting an action being a direct part of the exchange of a current sheet; and a data-stream insertion unit for inserting a new page indicator into a data stream emerging from the pen movements, at a location in the stream indicated by a time of the detecting, the new page indicator being a display instruction to separately display pen movements located before and after the new page indicator as separate pages.

### RELATIONSHIP TO EXISTING APPLICATIONS

This application claims the benefit of priority of U.S. Provisional Patent Application No. 61/142,921 filed on Jan. 7, 2009, the contents of which are hereby incorporated herein by reference.

### FIELD AND BACKGROUND OF THE INVENTION

The present invention relates to a device and method for page change indication for use with digital pens.

Digital pens typically write on paper and allow a nearby computer to pick up the movements so that a digital version of the writing or drawing can be captured. Sometimes the user may expect the movements to be displayed immediately on a screen but at other times the paper suffices, and the digital version is merely kept for future use.

Another version of a digital pen is used remotely from the PC. A receiver and pen combination allows for writing on paper with electronic detection of pen movements. The electronically stored handwritten data that results may later be downloaded by the user when he returns to his PC environment, where he can store or edit or share his data or convert the data to ASCII and search, say through meeting or lecture notes, all using the PC which was not present when the notes were taken.

Digital pen receivers typically comprise memory, and when the user writes in the presence of such a receiver, the handwriting may be stored inside the receiver's memory, irrespective of whether or not it is displayed.

When using a digital pen in the presence of a receiver, the digital representation of the data needs to have an indication as to when the user starts to write on a new page. Without this essential feature, the digital representation will show multiple pages on the same digital page, which will make the digital data very hard to read.

### EXISTING ART

The solution as of today, is to add a dedicated switch on the receiver. Pressing this switch places a new page indication in the data stream.

However, this solution is not user friendly, since it relies on the user to press a switch whenever he starts to write on a new page. Users often forget to perform this function, thus creating a mixed-up digital representation of their writing.

The above-described method is described in U.S. Pat. No. 6,232,962.

If the user is showing data on screen, and changes page while forgetting to press the indicator, overlaying will occur, and he will generally notice fairly quickly that the screen has not moved to a new page. But even so the correspondence between the paper and the digital version has been lost.

If the user is not currently showing data on the screen then forgetting to press the new page indicator can lead to numerous pages being mixed up together. In the case of note-taking remote from the PC the consequences of not paying attention to page changes may not become apparent until too late. The data as later displayed on the PC may be completely unreadable and useless.

### SUMMARY OF THE INVENTION

According to one aspect of the present invention there is provided a digital pen input system for allowing a user to write or draw by interacting with sheets of paper and allowing electronic tracing of pen movements for digital storage or display, the input device comprising a holder for sheets of paper, and a unit for detecting exchange of a current sheet, the system comprising:

a page change-intrinsic event detector for detecting an action being a direct part of the exchange of a current sheet;

a data-stream insertion unit for inserting a new page indicator into a data stream emerging from the pen movements, at a location in the stream indicated by a time of the detecting, the new page indicator being a display instruction to separately display pen movements located before and after the new page indicator as separate pages.

In an embodiment, the action being detected, which is a direct part of the sheet exchange, is a natural sheet exchange action.

An embodiment may comprise a barcode reader for reading barcodes on respective sheets in order to detect sheet exchange.

In an embodiment, the holder for sheets of paper comprises a clip for holding the sheets in position, the clip requiring opening in order to carry out sheet exchange, the direct action being the opening of the clip.

An embodiment may comprise a magnet mounted in association with the clip, such that opening of the clip causes a change in a magnetic field associated with the magnet, the change in magnetic field being detectable.

In an embodiment, the clip holds the sheets using tension and which clip requires temporary release of the tension to exchange a sheet, the detected action being a direct part of the current sheet exchange being the temporary release of the tension.

An embodiment may comprise at least one of a pressure switch and a contact switch for detecting the release of tension.

In an embodiment, the holder for sheets of paper comprises a paper holding clip which holds the sheets, the paper holding clip comprising a movement detector facing towards an uppermost one of the sheets to detect removal of the uppermost sheet, such that the action which is a direct part of the sheet exchange is the removal of the uppermost sheet.

In an embodiment, the opening comprises an angular change within the clip, the system comprising a detector to detect the angular change.

In an embodiment, the opening of the clip comprises movement of the clip, the system comprising a detector to detect movement of the clip.

In an embodiment, the movement detector comprises an internal motion detector within the clip.

In an embodiment, the movement detector comprises a movement detector external to the clip.

In an embodiment, the direct action comprises a user hand movement of the sheet exchange.

An embodiment may involve using image processing to detect sheet exchange from the user hand movement.

In an embodiment, respective sheets comprise sheet indicators and the detection comprises detection of a change of sheet indicator.

An embodiment may involve a user input on the pen to generate the sheet indicator.

An embodiment may comprise a post-processing unit for processing the pen movements to detect at least one indication of sheet exchange from the pen movements.

In an embodiment, the indications of sheet exchange from the pen movements comprise one member of the group consisting of: gradual progress over a surface from a start point to an end point followed by a jump back to the start point, movements being consistently made and overlapping with earlier movements, and gradual progress over a surface from a start point to an end point followed by a jump back to the start point at which start point movement overlaps with earlier movements.

According to a second embodiment of the present invention there is provided a digital pen input method for allowing a user to write or draw by interacting with sheets of paper and allowing electronic tracing of pen movements for digital storage or display, the input device comprising a holder for sheets of paper, and a unit for detecting exchange of a current sheet, the method comprising:

detecting an action being a direct part of the exchange of a current sheet;

inserting a new page indicator into a data stream emerging from the pen movements, at a location in the stream indicated by a time of the detecting, the new page indicator being a display instruction to separately display pen movements located before and after the new page indicator as separate pages.

According to a third embodiment of the present invention there is provided a detector assembly for use in a transcription system, the detector assembly comprising:

a housing for removeably mounting adjacent a writing surface;

a plurality of signal receivers attached to the housing for receiving position signals transmitted through the air from a pen when the pen is positioned adjacent the writing surface, the transcription system using times of flight of the position signals to determine positions of the pen relative to the writing surface, and converting the detected positions into a datastream; and

an event detector operative for detecting one or more user actions intrinsic to data input, and for converting the detected intrinsic action into a function relating to the datastream.

In an embodiment, the event is a user action intrinsic to a change in state of the datastream, such as the opening of a new file, the start of a new page, the deletion of a word, and others.

An embodiment may comprise an insertion unit associated with the function unit, the insertion unit being operative to associate the event with a location in the datastream and to insert a marker into the datastream at the location.

Unless otherwise defined, all technical and scientific terms used herein have the same meaning as commonly understood by one of ordinary skill in the art to which this invention belongs. The materials, methods, and examples provided herein are illustrative only and not intended to be limiting.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Implementation of the method and/or system of embodiments of the invention can involve performing or completing selected tasks manually, automatically, or a combination thereof.

Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified diagram illustrating a system for detecting an exchange of a sheet in a pen and digital input system according to an embodiment of the present invention;

FIG. 2 is a block diagram showing signal processing units for the system of FIG. 1 according to one embodiment of the present invention;

FIG. 3A shows a paper clip according to an embodiment of the present invention, in a closed position indicating no sheet exchange;

FIG. 3B shows the clip of FIG. 3A having been opened and indicating an act of sheet changing;

FIG. 4 is a simplified diagram showing typical pen movements over a sheet during handwriting; and

FIG. 5 is a simplified block diagram showing signal processing for detecting acts of sheet exchange based on pen movements such as shown in FIG. 4.

### DESCRIPTION OF THE PREFERRED EMBODIMENTS

The present embodiments comprise a way of providing a natural indication generated by the act of switching to a new sheet, and not requiring any side action by a user. The natural indication may be an indication that comes naturally with the changing or turning of the page, or is necessarily associated with the changing or turning of the page, or is a condition without which the page cannot reasonably be changed.

The indication may be interpreted as switching to a new page or sheet, but where appropriate may also be taken as starting a new file, and references hereinbelow to switching to a new sheet may be understood accordingly. Indications may also be detected that relate to other operations on an incoming datastream, and the indications may be inserted into a location in the incoming datastream that is associated with the indication.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

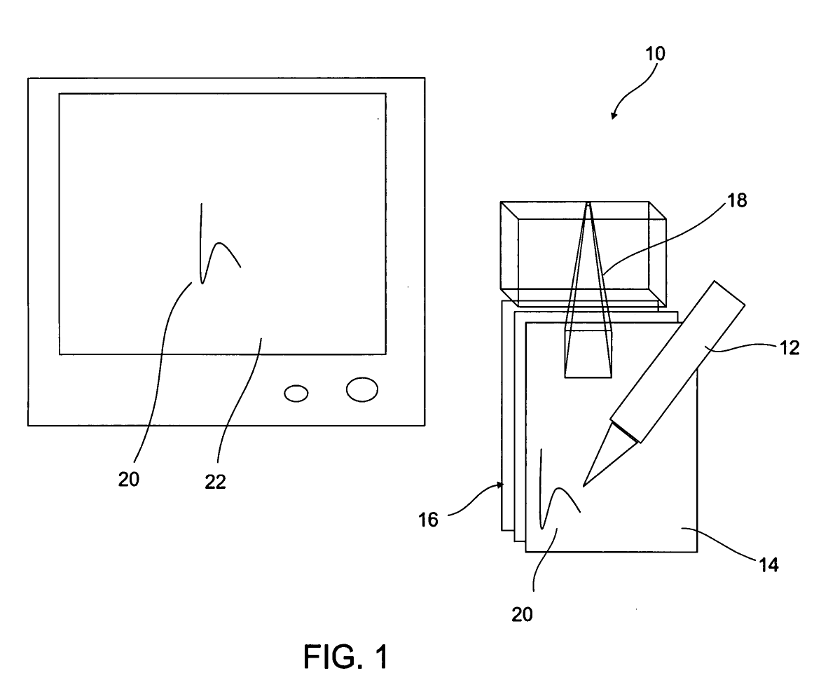

Reference is now made to FIG. 1 which illustrates a digital pen input system 10. A user operates pen 12 to write or draw on sheet 14 which is the upper sheet of a pad 16 of sheets. The pad is held down by holder 18 which may include a clip or paperweight or any other mechanism or way of holding paper. A user may write or draw by interacting with the sheets of paper using a pen and ink. Meanwhile, the movements of the pen are electronically traced as long as the pen is in contact with the paper. The results 20 of the tracing may be displayed on screen 22 and/or stored digitally for future display.

The movements of the pen are generally obtained by position detection of the pen over a period of time by position sensors associated with the system. Several methods of position detection are known to the skilled person. In one embodiment ultrasonic waves issued by the pen are differentially detected by microphones or ultrasonic sensors at different locations and the position of the pen is triangulated therefrom. In a variation, an ultrasonic baseband signal is modulated onto a carrier wave, for demodulation and differential detection at the microphones.

The user writes on sheet 14. If the user gets to the end of the sheet then the sheet is removed and the user begins writing or drawing again. However the screen 20 and associated needs to know if the sheet has been exchanged, otherwise writing intended for different sheets of paper will appear superimposed on the screen.

Thus system 10 includes an ability to detect whether sheet 14 has been exchanged with a different sheet. In the prior art the user was required to provide separate input to the system to indicate that the sheet was changed. System 10 however detects the sheet changing itself.

As part of changing the sheet, a number of acts are involved. These include releasing the sheet by moving or rotating clip 18, removing the sheet, moving the pen abruptly from a writing position at the lower end of the sheet to an upper end of the sheet, and the like. Any of these acts are naturally associated with the changing of a sheet.

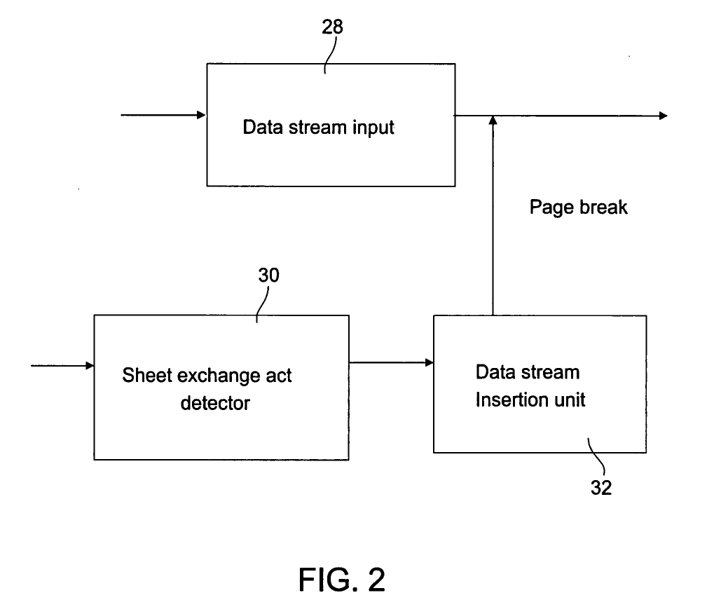

Reference is now made to FIG. 2, which is a simplified block diagram illustrating sheet changing detection components within the system of FIG. 1 according to an embodiment of the present invention.

A data stream input 28 receives movement data from the pen in the form of lines over a two dimensional surface.

A sheet exchange act detector 30 autonomously detects an activity which is a direct or natural part of the exchange of a current sheet, for example releasing the sheet by moving or rotating clip 18, removing the sheet, moving the pen abruptly from a writing position at the lower end of the sheet to an upper end of the sheet, and the like, as mentioned.

A data-stream insertion unit 32 obtains the indication that the sheet has been changed from the sheet exchange act detector and inserts a new page indicator into the data stream emerging from the pen movements. The insertion may be made at a location in the stream which is indicated by the time at which the detecting is made. The new page indicator may be a display instruction to separately display pen movements located before and after the new page indicator as separate pages. The new page indicator may be the feature known from word processing technology as a page break.

An example of such a detector is a switch that changes state when the paper holder performs a mechanical function such as used for adding a new sheet or removing the used sheet or otherwise replacing the paper.

It is also added that the paper holder may be booklet or folio. In this case, opening the folio may switch on the device and turning the pages may be directly detected to start a new sheet on the screen.

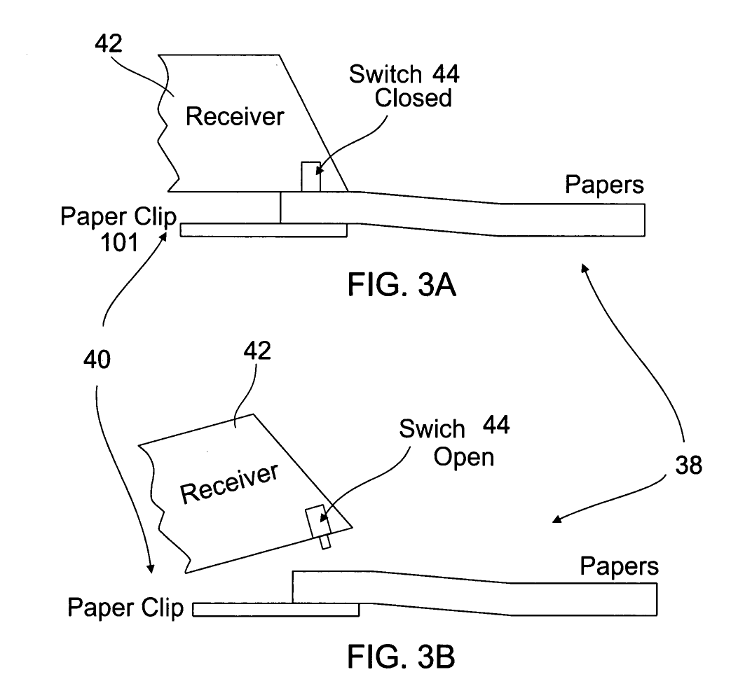

Reference is now made to FIGS. 3A and 3B, which show one embodiment of the sheet exchange action detector. A holder 38 contains a pad of paper or sheets of paper 39. The sheets or pad are held in position by a clip 40, and a receiver unit 42 which detects movement of the pen is built into the clip 42. A switch 44 is located in the upper part of the clip 40. The clip requires opening in order to carry out sheet exchange, so that the direct action of sheet exchange that is detected is the opening of the clip. Switch 44 may for example be a contact switch, or a pressure switch.

In the closed state of FIG. 3A the switch 44 remains in contact with the sheet. No sheet exchange is detected.

When the clip is opened, as shown in FIG. 3B, a signal indicating that the sheet has been changed is issued by the contact switch when contact with the sheet ceases.

Switch 44 may be part of a clip which may hold the sheets using tension. The clip may thus require temporary release of the tension to exchange a sheet. Thus in an embodiment the temporary release of tension may be the act detected that is a direct part of the current sheet exchange.

Switch 44 may alternatively include a magnetic detector to detect opening. For example, a magnet may be placed on the clip and another on the body of receiver. When the clip is opened the distance between the magnets increases, causing a weakend magnetic field which may be detected by a magnetic field detector.

In an embodiment the clip may be such that paper is simply slid in and out, without any release of tension. In such a case a movement detector may be mounted on the upper part of the clip to face downwards towards the upper sheet, that is to say in the same position as switch 44 in FIG. 3A. Movement detection may be via a beam of light and image processing of its reflection, as commonly used in the computer mouse. Movement of the sheet is a direct act of removal of the uppermost sheet.

Another way to measure movement of the paper is to use an IR transmitter and receiver which are directed to the paper held between the clip and the receiver body. A change in the received signal indicates that the paper has moved and that the user has exchanged a sheet.

Likewise the IR transmitter and receiver may be directed at the clip. Again, a change in the received signal indicates an act of exchanging the sheet.

As shown in FIG. 3B, the opening of the clip may comprise an angular change within the clip. The system may thus include a detector to detect the angular change.

Opening of the clip may comprise movement of the clip, and the system may include a detector to detect movement of the clip.

In one embodiment, the motion of the clip may be detected from within the clip, for example using a built in accelerometer. The accelerometer may thus comprise an internal motion detector within the clip, and specifically within the upper part of the clip that moves.

The accelerometers may be placed inside the receiver and measure the angle or attitude of the receiver. A change in the attitude indicates an act by the user to exchange a sheet. Likewise an accelerometer may sense that the receiver has been slightly lifted, again, to exchange a sheet.

In an alternative embodiment, the movement detector may comprise a movement detector external to the clip. For example a camera may be set on the clip and image processing may be used to detect motion.

As well as motion of the camera, motion of the user's hand or of the pen may be detected by the same camera, so that the direct action comprises a user hand movement which is a part of the sheet exchange. Thus image processing may be used to detect sheet exchange from the user hand movement.

The camera may combine indications from hand movement, clip movement and paper movement to come to decisions about whether a sheet has been exchanged.

In another embodiment, the individual sheets may include indicators. The receiver then simply needs to detect a change of indicator. In one example a code, for example a bar code, or writing or dots or the like, may be imprinted on the paper. The receiver 42 is provided with the ability to read the code, say via a bar code reader or a camera.

Identifying the individual pages allows a way of retrieving the pages from device memory. The current handwriting data stream may be associated with the particular page code so that the user is able to pull out a sheet, have the code read and automatically find the equivalent digital version. Alternatively the user may ask for a given page number and the image or writing may be automatically displayed.

As an alternative to a bar code or printed code, an RF-ID may be embedded within the paper.

In a variation of this embodiment, a user input may be provided on the pen to generate a sheet indicator. For example a pushbutton, or combination of buttons, may be provided which the user presses when starting a new page to provide a sequential marking to the page.

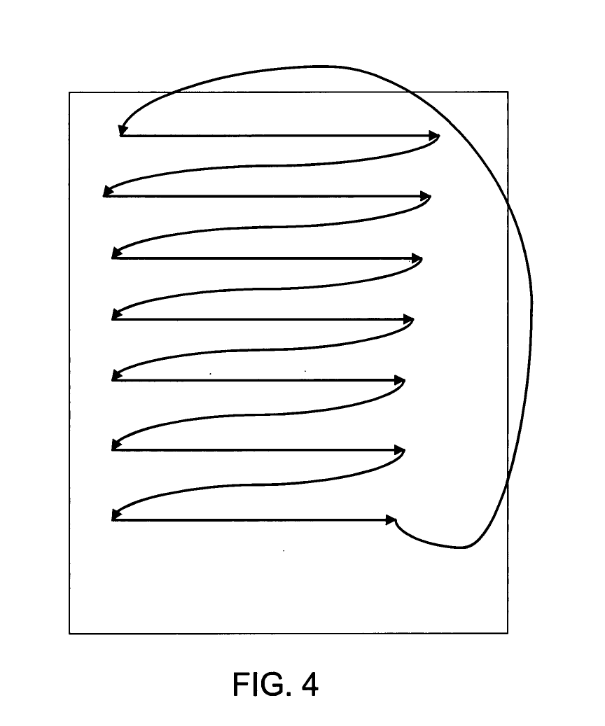

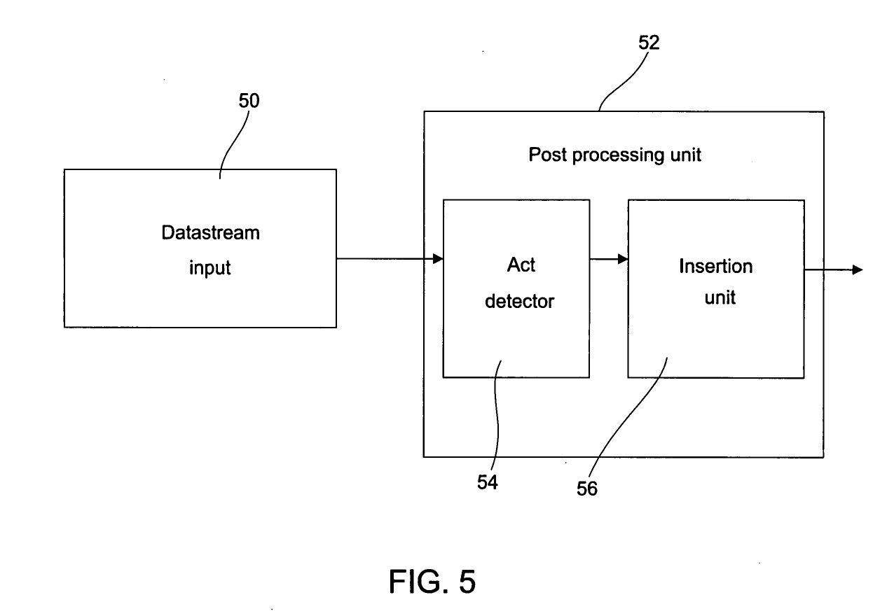

Reference is now made to FIG. 4, which is a simplified diagram illustrating pen movements during typical handwriting on a page. The pen writes in lines and then moves to a position below to start a new line. At the end of the page the pen moves back to the upper corner. Two embodiments detect this movement. In one embodiment the camera referred to above visually tracks the pen movement. A second embodiment is based on FIG. 5, in which post processing of the data stream is used to determine the writing position and thus deduce that the sheet has been changed.

In FIG. 5, datastream input block 50 passes the pen movements as an image to post processing unit 52. Post processing unit 52 follows the emerging lines on the data stream to determine the pen position. Discontinuities in the pen position are noted. In typical handwriting there are numerous discontinuities in the pen position, namely between letters, between words, for dotting “i”s and crossing ‘t’s etc, and between lines and paragraphs, but all of these are relatively small. A large discontinuity, beginning at around the bottom of the page and ending back at the top, may be distinguished from the other discontinuities and used to indicate a sheet exchange act at act detector 54. A page break may then be inserted by insertion unit 56.

It is noted that a large discontinuity may not in fact relate to a change in page. For example a user may return to earlier parts of the page to make an insertion or correct a spelling or the like. Such insertions may be distinguished from sheet exchanges by a persistency test. A sheet exchange event may be provisionally recognized but only finally set when a threshold amount of consistency is found with the new position. That is to say the user continues to progress through the page from the same position. If the user makes a small change at one position and then jumps to another for a small change, and both small changes are consistent with existing writing locations then the system may decide that it is looking at corrections and not at a sheet exchange event.

Alternatively, a superposition test may be applied. If the new writing position is found to be inconsistent with writing already present, say handwriting lines interfere with each other, then the new position may be confirmed as a new page.

The post-processing unit may use more than one test for processing the pen movements to detect an indication of sheet exchange and the different tests may be used in combination, say by voting.

FIG. 4 shows gradual progress over a surface from a start point to an end point followed by a jump back to the start point. An alternative test involves movements being consistently made and overlapping with earlier movements. The combination may involve gradual progress over a surface from the start point to the end point followed by a jump back to the start point, at which start point movement overlaps with earlier movements.

Additional options may rely on an indication naturally provided by the user when starting a new page. The user may for example write the page number on a pre-determined area, or using a pre-determined gesture. Such a gesture can be a page number encircled twice, or a gesture in the air.

Other movements may be recognized, either from processing of the received movements or from movement detection of the user. For example, scribbling over a word may be interpreted as deletion of the word. Furthermore, if the user goes back from the bottom of a page to the top of the page but scribbles over a word, then a determination of scribbling as deletion of a word may in fact override a corresponding determination of starting a new page.

Voice commands may also be recognized, particularly from microphones which are operating in any event to detect location.

Any of the above-discussed intrinsic actions may be detected and inserted as a marker into the incoming datastream from the pointing device. The marker may relate to changing of a sheet, or starting a new file or to any other state change in the data or operation on the data.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A digital pen input system for allowing a user to write or draw by interacting with sheets of paper and allowing electronic tracing of pen movements for digital storage or display, the input device comprising a holder for sheets of paper, and a unit for detecting exchange of a current sheet, the system comprising:
a page change-intrinsic event detector for detecting an action being a direct part of said exchange of a current sheet;
a data-stream insertion unit for inserting a new page indicator into a data stream emerging from said pen movements, at a location in said stream indicated by a time of said detecting, said new page indicator being a display instruction to separately display pen movements located before and after said new page indicator as separate pages.

2. The system of claim 1, wherein said action being detected, which is a direct part of said sheet exchange, is a natural sheet exchange action.

3. The system of claim 2, further comprising a barcode reader for reading barcodes on respective sheets in order to detect sheet exchange.

4. The system of claim 1, wherein said holder for sheets of paper comprises a clip for holding said sheets in position, said clip requiring opening in order to carry out sheet exchange, said direct action being said opening of said clip.

5. The system of claim 4, further comprising a magnet mounted in association with said clip, such that opening of said clip causes a change in a magnetic field associated with said magnet, said change in magnetic field being detectable.

6. The system of claim 4, wherein said clip holds said sheets using tension and which clip requires temporary release of said tension to exchange a sheet, said detected action being a direct part of said current sheet exchange being said temporary release of said tension.

7. The system of claim 6, comprising at least one of a pressure switch and a contact switch for detecting said release of tension.

8. The system of claim 1, wherein said holder for sheets of paper comprises a paper holding clip which holds said sheets, said paper holding clip comprising a movement detector facing towards an uppermost one of said sheets to detect removal of said uppermost sheet, such that said action which is a direct part of said sheet exchange is said removal of said uppermost sheet.

9. The system of claim 4, wherein said opening comprises an angular change within said clip, said system comprising a detector to detect said angular change.

10. The system of claim 4, wherein said opening of said clip comprises movement of said clip, said system comprising a detector to detect movement of said clip.

11. The system of claim 10, wherein said movement detector comprises an internal motion detector within said clip.

12. The system of claim 10, wherein said movement detector comprises a movement detector external to said clip.

13. The system of claim 1, wherein said direct action comprises a user hand movement of said sheet exchange.

14. The system of claim 13, comprising using image processing to detect sheet exchange from said user hand movement.

15. The system of claim 1, wherein respective sheets comprise sheet indicators and said detection comprises detection of a change of sheet indicator.

16. The system of claim 15, further comprising a user input on said pen to generate said sheet indicator.

17. The system of claim 1, further comprising a post-processing unit for processing said pen movements to detect at least one indication of sheet exchange from said pen movements.

18. The system of claim 17, wherein said indications of sheet exchange from said pen movements comprise one member of the group consisting of: gradual progress over a surface from a start point to an end point followed by a jump back to said start point, movements being consistently made and overlapping with earlier movements, and gradual progress over a surface from a start point to an end point followed by a jump back to said start point at which start point movement overlaps with earlier movements.

19. A digital pen input method for allowing a user to write or draw by interacting with sheets of paper and allowing electronic tracing of pen movements for digital storage or display, the input device comprising a holder for sheets of paper, and a unit for detecting exchange of a current sheet, the method comprising:
detecting an action being a direct part of said exchange of a current sheet;
inserting a new page indicator into a data stream emerging from said pen movements, at a location in said stream indicated by a time of said detecting, said new page indicator being a display instruction to separately display pen movements located before and after said new page indicator as separate pages.

20. A detector assembly for use in a transcription system, the detector assembly comprising:
a housing for removeably mounting adjacent a writing surface;
a plurality of signal receivers attached to the housing for receiving position signals transmitted through the air from a pen when the pen is positioned adjacent the writing surface, the transcription system using times of flight of the position signals to determine positions of the pen relative to the writing surface, and converting said detected positions into a datastream; and
an event detector operative for detecting one or more user actions intrinsic to data input, and for converting said detected intrinsic action into a function relating to said datastream.

21. The assembly of claim 20, wherein said event a user action intrinsic to a change in state of said datastream.

22. The assembly of claim 20, further comprising an insertion unit associated with said function unit, said insertion unit being operative to associate said event with a location in said datastream and to insert a marker into said datastream at said location.
